(19) United States
(12) Patent Application Publication
(10) Pub. No.: US 2012/0122421 A1
(43) Pub. Date: May 17, 2012

(54) SYSTEM AND METHOD FOR REDUCING LATENCY IN A WIRELESS LOCATION SYSTEM

(75) Inventors: Mario Proietti, Fullerton, CA (US); Daniel A. Lambert, Carlsbad, CA (US); Samuel Charles Knight, Del Mar, CA (US); John Thomas Moring, Encinitas, CA (US)

(73) Assignee: TECHNOCOM CORPORATION, Encino, CA (US)

(21) Appl. No.: 12/946,678

(22) Filed: Nov. 15, 2010

(51) Int. Cl. H04W 12/00; H04W 4/02

(52) U.S. Cl. 455/410; 455/456.2

(57) ABSTRACT

A system and method for providing a location of a mobile device in a network. The method includes: receiving a location request; determining the location of the mobile device responsive to the location request; holding the determined location of the mobile device until a permission to send the determined location is received; receiving the permission to send the determined location; and transmitting the determined location of the mobile device responsive to the received permission.

### FIELD OF INVENTION

The present invention relates generally to the field of mobile wireless communication systems, more particularly to the location of mobile devices within a network.

### BACKGROUND

Radiolocation of mobile devices developed in the last half of the 20^{th} century, notably with the deployment of the Global Positioning System (GPS). By the turn of the century, US cellular carriers deployed location-determination technology in their networks in support of emergency (E9-1-1) services. With the subsequent ubiquitous availability of cellular phone location capabilities, numerous applications utilizing the location of the mobile devices have been made available for such uses as direction finding, tracking individuals, and matching persons with nearby businesses.

There are delays associated with the granting of these location services. A delay may be due to collecting network or satellite measurements and computing a resulting location, and verifying or obtaining user permission to be located.

There is an understanding that users of location services should have the option whether to engage in any services that might compromise their privacy through the use of their location. In that light, a user's permission is often required before a locating process takes effect. This collecting of permissions, however, adds additional delay to the fulfillment of the location service.

The present invention is directed to a new scheme which starts the location determination process earlier, even before the permission is granted, while still respecting the user's privacy. It thus has the effect of lessening the overall time to complete the service, resulting in higher satisfaction and value to the user.

### SUMMARY

In some embodiments, the present invention is a method for providing a location of a mobile device in a network. The method includes: receiving a location request; determining the location of the mobile device responsive to the location request; holding the determined location of the mobile device until a permission to send the determined location is received; receiving the permission to send the determined location; and transmitting the determined location of the mobile device responsive to the received permission.

A request for permission may also be made by the mobile device or other related entities. Determining the location may start before, or be performed simultaneously with requesting the permission.

In some embodiments, the present invention is a system for providing a location of a mobile device in a network. The system includes: a communications module for receiving a location request; a location determining module for determining the location of the mobile device responsive to the location request; and a storage module for holding the determined location of the mobile device until a permission to send the determined location is received; wherein the communications module is configured to receive the permission to send the determined location and to transmit the determined location of the mobile device responsive to the received permission.

The storage module may be in the mobile device or within the network.

In some embodiments, the present invention is a method for providing a location of a mobile device in a network. The method includes: receiving a location request; determining the location of the mobile device responsive to the location request; encrypting the determined location of the mobile device; and decrypting the determined location of the mobile device responsive to a received permission.

The method may further include receiving a decryption key when the permission to send the determined location is received and decrypting the determined location using the received decryption key.

In some embodiments, the present invention is a system for providing a location of a mobile device in a network. The system includes: a communications module for receiving a location request; a location determining module for determining the location of the mobile device responsive to the location request; a locking module for encrypting the determined location of the mobile device until a permission to send the determined location is received; wherein the communications module is configured to transmit the encrypted location of the mobile device, request the permission to send the determined location, and to transmit a decryption key to decrypt the encrypted location, responsive to the received permission.

The mobile device may be any mobile computing device including a cell phone, a computer, a Personal Digital Assistant (PDA), or any other mobile computing device; and the network may be any network including a cellular network, a Wi-Fi network, an Ethernet network, a radio network, and or satellite network.

### BRIEF DESCRIPTION OF THE DRAWINGS

FIG. 1 shows a block diagram of a wireless system offering location based services, according to prior art.

FIG. 2 is an exemplary block diagram of a general system, according to some embodiments of the present invention.

FIG. 3. illustrates an example of an information flow used to provide location services, according to the prior art.

FIG. 4. illustrates an exemplary information flow for providing location services using an escrow function, according to some embodiments of the present invention.

FIG. 5. illustrates an improved timeline of information flow for providing location services, according to some embodiments of the present invention.

FIG. 6 shows an exemplary information flow for providing location services using locked location data, according to some embodiments of the present invention.

FIG. 7 shows an exemplary information flow for providing location services where the location data is held pending permissions, according to some embodiments of the present invention.

FIG. 8 is an exemplary block diagram, according to some embodiments of the present invention.

FIG. 9A shows the process flow of a location function in accordance with prior art.

FIG. 9B shows an exemplary process flow of a location function, according to some embodiments of the present invention.

FIG. 10 illustrates a timeline of information flow for providing location services, according to the prior art.

### DETAILED DESCRIPTION

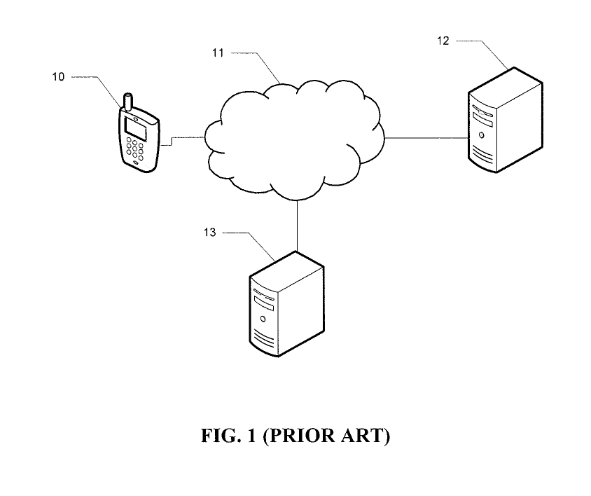

FIG. 1 illustrates an exemplary block diagram of a general location system, according to prior art, for example, in a modern cellular system. A mobile device 10 makes use of the system, including using it for location services. The mobile device 10 has connectivity through communication facilities 11 (e.g., network or networks) to additional entities. A location service provider 12 offers services specific to the current location of the mobile device. Examples would be the calculation of directions to a location, or identification of the closest retail establishment of a specific type. The mobile device may be a phone, a computer, a PDA device, and the like.

A location determination function 13 is responsible for collecting measurement information and determining the current location of the mobile device. There are numerous ways that this may be accomplished. For example, the mobile device may collect signal measurements (e.g., GPS, cellular), or signals from the mobile device might be collected by other measurements devices. The mobile device's location might be deduced from knowledge about its connection point to the network. The location determination function 13 might reside at the mobile device 10, at the location service provider 12, for example, on a server computer, or elsewhere.

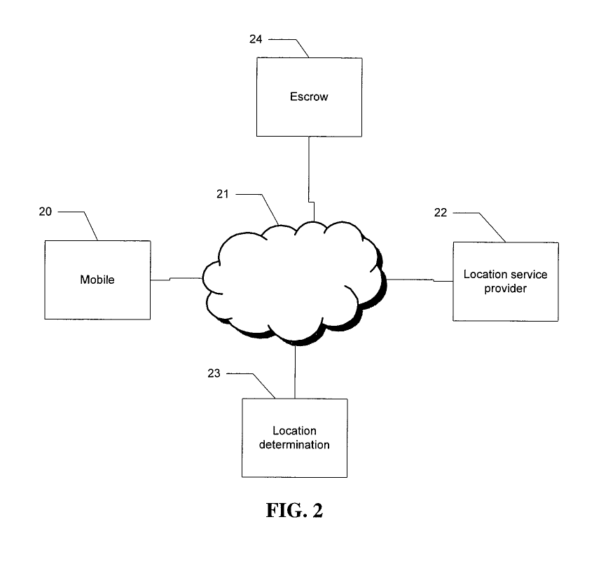

FIG. 2 is an exemplary block diagram of a general system, according to some embodiments of the present invention. As shown, an escrow function 24 provides features unique to the present invention. The escrow function 24 acts as an intermediary between the location determination function 23 and the location service provider 22, or any other third party locations. The mobile device may be a phone, a computer, a PDA device, and the like. The communication facilities 21 may include any combination of wireless, wired, or other link types. Link types of specific interest in today's technology include satellite and 2G/3G/4G cellular wide area networks, and wireless (e.g., Wi-Fi) or wired (e.g., Ethernet) local area networks. Accordingly, the network may be a cellular network, a Wi-Fi network, an Ethernet network, a radio network, a satellite network, and the like.

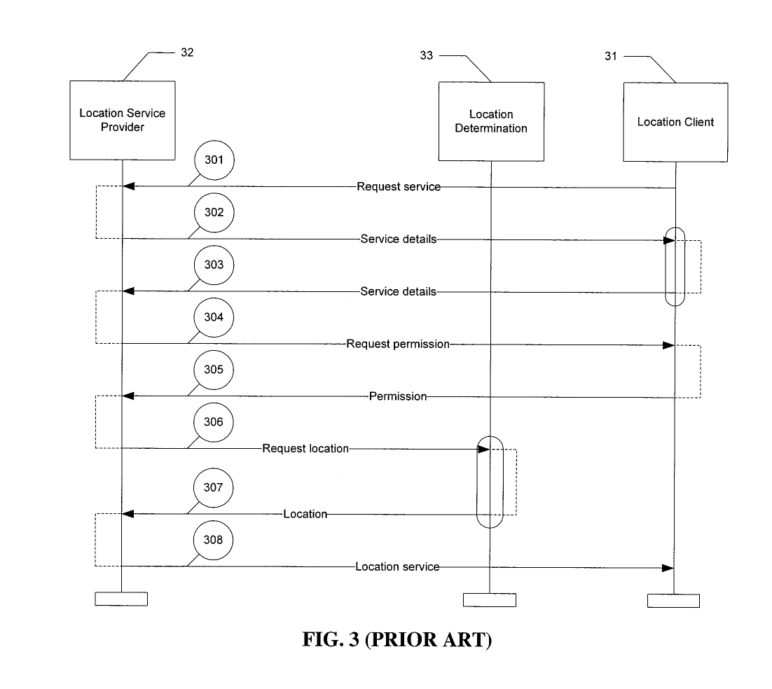

FIG. 3. illustrates an example of an information flow used to provide location services, according to the prior art. A location client 31 requests 301 a location service from a location service provider 32. Subsequently, service details are exchanged 302, 303. (Dotted lines indicate the relationship between a response and a request.) These details might include multiple interactions (not explicitly shown in FIG. 3) and contain more specifics about the location client, the user, or aspects of the service (e.g., “find a Brand X gas station within 5 miles”). The service details exchange may include interaction with location client software and/or the mobile device user.

Next, the location service provider requests permission 304 to locate the mobile device from the location client. The permission 305 is returned, perhaps after interaction with the mobile device user at the location client.

Because of privacy issues, the location service provider requests the location 306 of the mobile device from the location determination function 33 only after receipt of the permission (and the service details) On receipt of the request 306, including the permission credentials, the location determination function verifies the permission credentials and then performs the processing, perhaps including data exchanges with other entities, needed to calculate the location of the mobile device. On completion of the location calculation, the location response is returned 307 to the location service provider. If the permission is not present or can not be verified, the location determination function may not be authorized to return the location.

Upon receipt of the location information 307, the location service provider can use it to complete the calculations needed to provide the location service 308 to the location client.

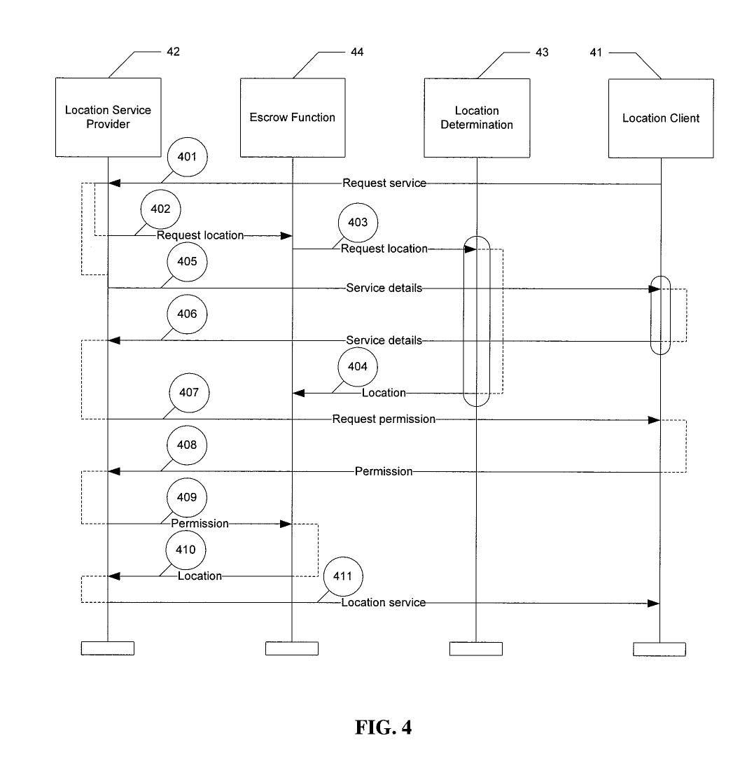

FIG. 4. illustrates an exemplary information flow for providing location services using an escrow function, according to some embodiments of the present invention. As shown, the process is triggered by a request for service 401 at the location service provider 42. Note that the service is shown originating at the location client, but may originate at some other entity. In the present invention, the location request 402 is sent to the escrow function 44. The escrow function in turn sends a location request 403 to the location determination function 43. This allows the location process, which is often time consuming, to be performed in parallel with the subsequent steps. Some time later, the location 404 is returned to the escrow function. The escrow function then holds the location 404 until the permission credentials are received 409 and their verification allows its release.

In parallel, the location service provider can proceed as before, exchanging service details 405, 406 with the location client, and eventually requesting permission 407 and receiving the permission 408 to locate.

The sequence of events can vary without changing the nature of the invention. For example, the original location request 402 might occur after some of the service details 405, 406 are exchanged. The location 404 response might occur during the service detail 405,406 or permission 407, 408 exchanges. Likewise, the information flow might involve a somewhat different collection of entities, depending on the implementation of the invention. For example, the permission might not be obtained directly from the location client, but could be obtained out of band from the location client or through an intermediary.

Once permission 408 is received by the location service provider, the provider in turn can retrieve the location 410 from the escrow function by presenting the permission credentials 409. Once the location service provider has the location 410, it then provides the location service 411 to the location client.

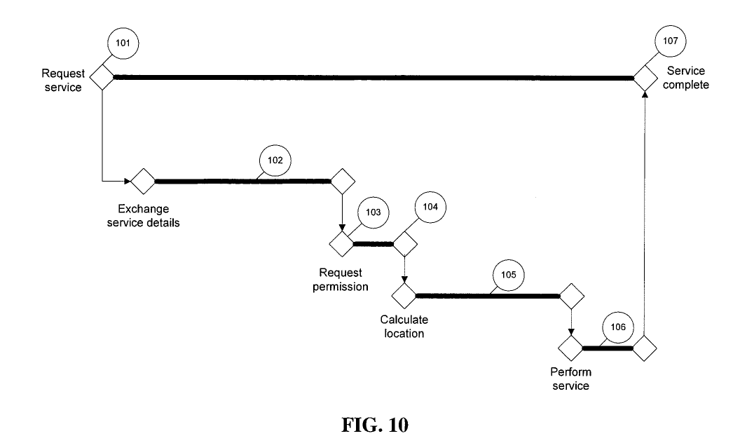

FIG. 10 illustrates a timeline of information flow for providing location services in accordance with prior art. The service 101 is initiated by a request. Service details are exchanged 102 and permissions requested 103. After permission is received 104, the location calculation 105 may proceed. After the location calculation, the service may be performed 106 and completed 107.

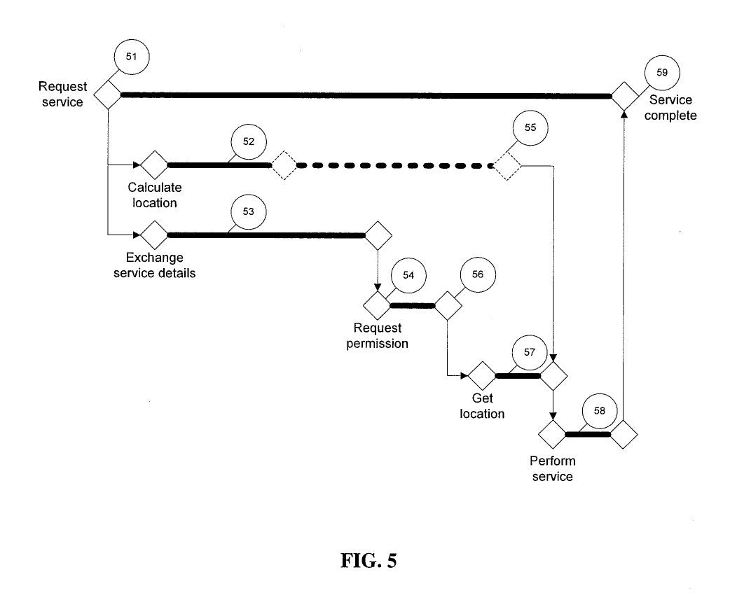

FIG. 5. illustrates an improved timeline of information flow for providing location services, according to some embodiments of the present invention. The service 51 is initiated by a request. The location calculation 52 proceeds in parallel with the exchanging of service details 53 and requesting of permission 54. Note that the permission request is shown sequential to the exchange of service details, but in a given implementation could be accomplished prior to or during the exchange of service details. In some implementations, the exchange of service details may be minimal or non-existent.

Also depending on the characteristics of the system, the location calculation 52 may be relatively longer or shorter than the other functions, as indicated by the dotted timeline for that function.

After the location is determined 55 and the permission is received 56, the location may be retrieved 57, and the service performed 58 and completed 59.

The escrow function plays a special role in this process. Unlike the location service provider, the escrow function is trusted to hold the location of the mobile device before the user's permission has been granted. It is desirable to begin the location calculation before user permission has been received, but access to the location requires either an explicit permission or a measure of trust in the accessing party. It is infeasible to verify the trustworthiness of every location service provider, but it is conceivable to verify trust in one escrow function that can then support many location service providers.

There are different methods to achieve trustworthiness in the escrow module. One method is via physical security. For example, the function might be contained within a cellular carrier's network, when the carrier is trusted through its relationship with it customer, the user of the mobile device. In another method, the escrow is trusted through electronic security means. For example, the location data might be passed to the escrow function in encrypted form, with only the location service provider having the security key with which to unlock and read the data. Regardless of the method of ensuring trust, the trustworthiness of the escrow function can be verified via audit.

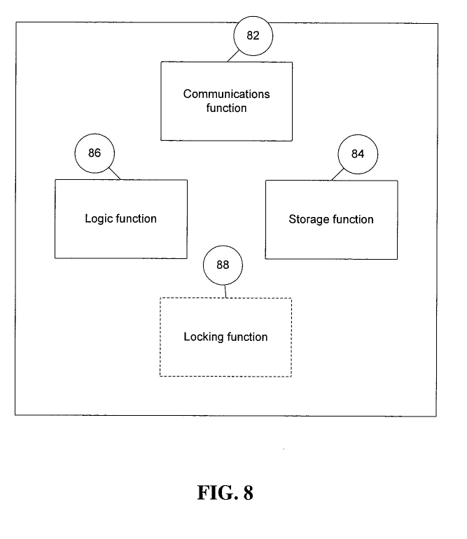

FIG. 8 is an exemplary block diagram, according to some embodiments of the present invention. A communications module 82 allows information transfer between the escrow module and other entities, such as location determination. A storage module 84 allows temporary or permanent storage of data, such as location data and permission data. A logic module 86 implements the information sequences and permission checks described herein. An escrow/locking module 88 performs the escrow functions describe above and below. An optional locking module, includes key generation and encryption functions may be used with some embodiments of the invention, described below. A location determining module, within the system of the present invention or outside of it, determines the location of the mobile device.

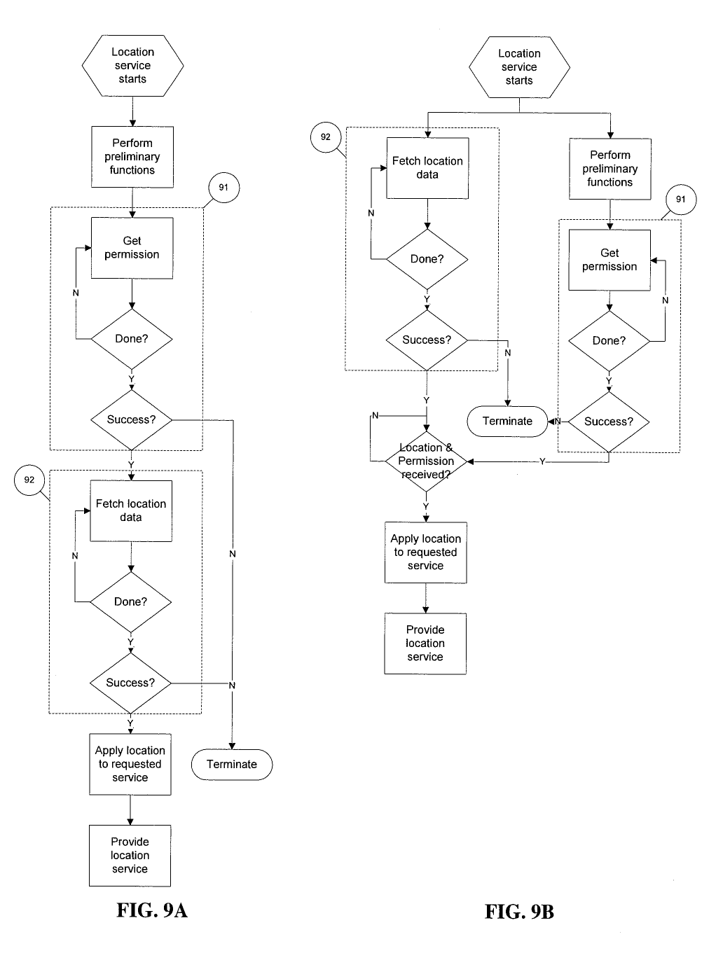

FIG. 9A shows the process flow of a location function in accordance with prior art; and FIG. 9B shows an exemplary process flow of a location function, according to some embodiments of the present invention. As shown in FIG. 9A, in the prior art, the permission phase 91 and the location fetch phase 92 are performed in series. In contrast, in the present invention, the permission phase 91 and the location fetch phase 92 are performed in parallel, as shown in FIG. 9B, resulting in improved performance.

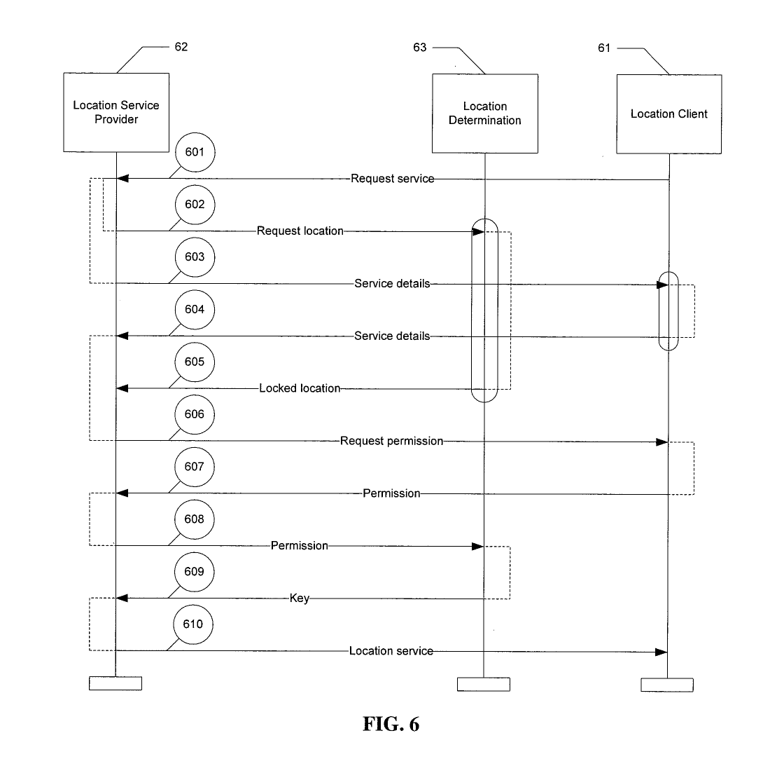

FIG. 6 shows an exemplary information flow for providing location services using locked location data, according to some embodiments of the present invention. As shown, a locking feature to protect the location data until the permission has been received. Here, the Location Client 61 requests service 601 of the Location Service Provider 62, as before. However, in this case, the Location Service Provider triggers the location request 602 directly. In the mean time, service details 603, 604 are exchanged.

When the location determination is completed, the Location Determination function returns a locked location 605. The locking function prevents the reading of the location information without an associated key. The locking may be accomplished via an encryption algorithm, such as encryption using public/private keys, digital signature, hashing algorithm, or any other locking schemes. Though the Location Service Provider is given the locked location data, it is not given the key until permission has been granted. The location determination function is shown completing after the exchange of service details 604. This order is not required by all embodiments of the present invention, rather, the process may complete any time following the location request 602.

As before, permission for locating the mobile is obtained at 606, 607. Following that exchange, the permission credentials 608 are provided to the Location Determination, which then returns the key 609. By unlocking the previously-acquired location data with the key, the Location Service Provider has access to the location data, and can provide the location service 610.

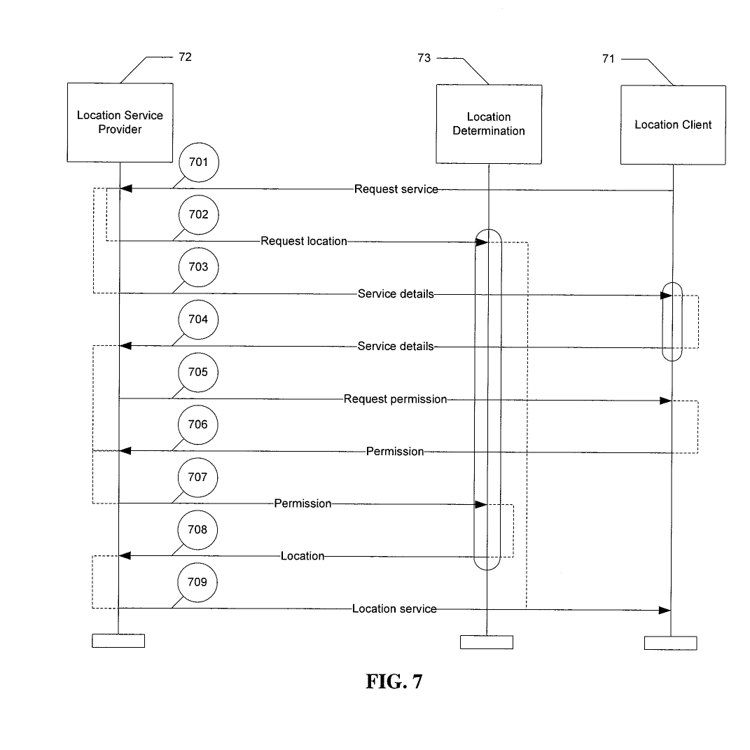

FIG. 7 shows an exemplary information flow for providing location services where the location data is held pending permissions, according to some embodiments of the present invention. Here, a holding feature to protect the location data until the permission has been received. As shown, the Location Client 71 requesting service 701 of the Location Service Provider 72, as before. The Location Service Provider triggers the location request 702 directly. In the mean time, service details 703, 704 are exchanged.

When the location determination is completed, the Location Determination function holds the location pending receipt of the permission. The hold function prevents the disclosure to an unauthorized entity. The location determination process may complete any time following the location request 702, and in fact the process may continue to refine the location estimate up until the time when the location data is delivered 708.

As before, permission for locating the mobile is obtained 705, 706. Following that exchange, the permission credentials 707 are provided to the Location Determination function, which then returns the location 708. The Location Service Provider now has access to the location data, and can provide the location service 709.

It will be recognized by those skilled in the art that various modifications may be made to the illustrated and other embodiments of the invention described above, without departing from the broad inventive scope thereof. It will be understood therefore that the invention is not limited to the particular embodiments or arrangements disclosed, but is rather intended to cover any changes, adaptations or modifications which are within the scope and spirit of the invention as defined by the appended claims.

What is claimed is:

1. A method for providing a location of a mobile device in a network, the method comprising:
receiving a location request;
determining the location of the mobile device responsive to the location request;
holding the determined location of the mobile device, until a permission to send the determined location is received;
receiving the permission to send the determined location; and
transmitting the determined location of the mobile device responsive to the received permission.

2. The method of claim 1, wherein the mobile device is one of the group consisting of a cell phone, a computer, and a PDA.

3. The method of claim 1, wherein the network is one of the group consisting of a cellular network, a Wi-Fi network, an Ethernet network, a radio network, and a satellite network.

4. The method of claim 1, further comprising requesting the permission to send the determined location.

5. The method of claim 4, wherein determining the location starts before requesting the permission.

6. The method of claim 4, wherein determining the location is performed simultaneously with requesting the permission.

7. A system for providing a location of a mobile device in a network comprising:
a communications module for receiving a location request;
a location determining module for determining the location of the mobile device responsive to the location request; and
a storage module for holding the determined location of the mobile device, until a permission to send the determined location is received, wherein the communications module is configured to receive the permission to send the determined location and to transmit the determined location of the mobile device responsive to the received permission.

8. The system of claim 7, wherein the storage module is in the mobile device.

9. The system of claim 7, wherein the storage module is within the network.

10. The system of claim 7, wherein the storage module is in a third-party location different than the network and accessible by the network.

11. A method for providing a location of a mobile device in a network, the method comprising:
receiving a location request;
determining the location of the mobile device responsive to the location request;
encrypting the determined location of the mobile device; and
decrypting the determined location of the mobile device responsive to a received permission.

12. The method of claim 11, further comprising receiving a decryption key when the permission to send the determined location is received and decrypting the determined location using the received decryption key.

13. The method of claim 11, further comprising transmitting the decrypted location of the mobile device.

14. The method of claim 11, further comprising:
transmitting the encrypted location of the mobile device to the mobile device;
transmitting a decryption key to the mobile device, when the permission to send the determined location is received, wherein decrypting the determined location is performed by the mobile device.

15. The method of claim 11, wherein the network is one of the group consisting of a cellular network, a Wi-Fi network, an Ethernet network, a radio network, and a satellite network.

16. The method of claim 11, wherein the permission to send the determined location is received from the mobile device.

17. The method of claim 11, wherein the permission to send the determined location is received from an entity other than the mobile device.

18. A system for providing a location of a mobile device in a network comprising:
a communications module for receiving a location request;
a location determining module for determining the location of the mobile device responsive to the location request;
a locking module for encrypting the determined location of the mobile device, until a permission to send the determined location is received, wherein the communications module is configured to transmit the encrypted location of the mobile device, and to transmit a decryption key to decrypt the encrypted location, responsive to a received permission.

19. The system of claim 18, wherein the encrypted location of the mobile device and the decryption key to decrypt the encrypted location are transmitted to the mobile device.

20. The system of claim 18, wherein the encrypted location of the mobile device and the decryption key to decrypt the encrypted location are transmitted to an entity other than the mobile device, wherein the entity other than the mobile device decrypts the location.
